(19) United States
(12) Patent Application Publication
(10) Pub. No.: US 2017/0116877 A1
(43) Pub. Date: Apr. 27, 2017

(54) Gross Motor Skills Booster Program Designed for Early Childhood

(71) Applicant: Norberto Rivera-Rodriguez, Bayamon, PR (US)

(72) Inventor: Norberto Rivera-Rodriguez, Bayamon, PR (US)

(21) Appl. No.: 14/919,932

(22) Filed: Oct. 22, 2015

(51) Int. Cl. G09B 19/00

(52) U.S. Cl. CPC G09B 19/003

(57) ABSTRACT

A system designed to develop gross motor skills of children during early childhood stage. Said system utilizes a mat with a thematic pre-designed obstacle course simulating a jungle printed on said mat as base for children to exercise on. Said system uses additional training equipment to increase difficulty and target additional age levels, such as ‘rubberized hurdles’, ‘cone toppers’, and a ‘jump n' touch’. Said system targets lower body strength, upper body strength, balance, spatial awareness and coordination. All the exercises promoted on said mat are classroom proven effective and will strengthen the targeted skills. Children emit effort through fun stimulus, thus children will be developing gross motor skills without noticing it.

### STATEMENT REGARDING FEDERALLY SPONSORED RESEARCH AND DEVELOPMENT

N/A

### RELATED APPLICATIONS

N/A

### BACKGROUND OF THE INVENTION

Field of the Invention

This invention relates generally to a system comprising a floor mat and additional training equipment used for exercises and educational purposes and more particularly to a thematic obstacle course exercise system used to develop various motor skills during early childhood.

Discussion of the Background

Gross motor skills are the abilities that should ideally be acquired during infancy and early childhood as part of a child's motor development. By the time they reach two years of age, almost all children should be able to stand up, walk and run, walk up stairs, etc. These skills are built upon, improved and better controlled throughout early childhood, and continue in refinement throughout most of the individual's years of development into adulthood. These gross movements come from large muscle groups and whole body movement. These skills follow a pattern of development of certain skills from basic to complex. Said skills should be introduced in an age appropriate manner.

When functional training is applied to children, you have a fully developmental gross motor development program. Scientific studies prove that children learn more from zero to five years of age than from five on. Early intervention of fitness education and skills is now pertinent given today's social demand for children health.

There is an existing necessity for toys and sports equipment for children that specifically target the development of gross motor skills. At this age, most form of training must be done through fun stimulus. In this case, a system consisting of a rubberized surface with an obstacle course printed on it and additional training equipment make this a challenging but fun activity.

Modern society must look for ways to increase the amount of physical exposure children are receiving. Therefore one of the objects of the present disclosure is to develop children's gross motor skills while they're having fun. Some of these skills are: balance, coordination, upper-body strengthening and lower-body strengthening, spatial awareness, agility, among others. It's the main purpose of the invention to develop these skills during early childhood. All Skills targeted in this system are age appropriate.

Patent App. Pub. No. US 2009/0191528 A1, discloses a motor and cognitive skills development system which includes a series of exercise mats having various instructional patterns with increasing degrees or levels of physical and mental difficulty from very basic to more advanced moves and instructions. The instructions may range from simple representations of foot patterns through representations of various objects, colors, alphanumeric indicators, caricatures, etc.

Patent App. Pub. Flo. US 2013/0089852 A1, discloses a method of teaching and learning using activity mats that allow students to physically move as they learn the relationships of abstract concepts thus using more learning modalities (visual, auditory, motor, and kinesthetic).

U.S. Pat. No. 3,879,034 discloses a game including a plurality of randomly oriented pairs of footprints, located in a prescribed area. A player must successfully jump into the area and align his feet onto each of the pairs of footprints in the area, jumping from one pair of footprints to another pair until he has jumped on all footprints in the area.

U.S. Pat. No. 5,156,409 discloses an active learning game, where game pieces are provided of sufficient size so that a child may hop from one to the other safely, with the surfaces having sufficient coefficients of friction so that the force of the child jumping onto them does not cause the child to slip nor cause the game pieces to slide and with top surfaces being marked with numbers, shapes, letters or word that are to be recognized by the child.

U.S. Pat. No. 7,481,726 B2 discloses a game apparatus and method wherein one or more players move along a path according to predetermined rules of movement. The path is a sequence of adjacent boxes outlined in the path; and graphics are associated with each box, wherein the graphics designate one or more body parts of the player moving along the path that must touch a playing surface of the associated box.

Accordingly, there remains a need for an improved exercises and educational floor mat to overcome the disadvantages and shortcomings of the prior art.

### SUMMARY OF THE INVENTION

The present invention is a thematic pre-designed obstacle mat simulating a jungle that acts as a motor-skills boosting program. The system comprises a platform wherein said platform comprises a non-slippery semi firm surface such as a rubberized surface that will provide stability with the floor and appropriate non-slipping surface for exercises. Said platform is made to be as big as 18 ft×12 ft. 100% of the mat is covered in design. Each item of the platform targets a different motor skill. This obstacle course targets: Lower-body strengthening (frog jumps from lily pads to lily pads), upper body strengthening (crawling following cheetah paws), balance (cross a log floating on water), and coordination (run in zigzag through desert rocks). The platform comprises a starting position. The starting position is marked with a first indicia, wherein said indicia is represented by the word “start” printed on the platform right before a second indicia wherein the second indicia is represented by a log floating on blue water. The log is brown with ridges and has 4 crocodiles showing their heads, two on each side. On one side is the corner of the mat which has green bushes and on the other side, in the same water, it has lily pads. There are eleven lily pads. Next to the lily pads, there is cracked stone with cheetah paws printed on it. Next to that there is a sand trail with a green gecko zig-zagging around the rocks all the way to the word “finish” which is printed at the end. Other floor mats educational systems are shown, for example, in Patent App. Pub. No. US 2009/0191528 A1 and US 2013/0089852 A1.

According to a first aspect of the invention, a thematic pre-designed obstacle mat is disclosed. The mat's upper surface comprises a resemble skill developing playing zone such as a jungle.

According to another aspect of the invention, the mat will have a rubberized surface that will provide stability with the floor and appropriate non-slipping surface for exercises.

According to a further aspect of the invention, the mat will be used to work as a gross motor-skills boosting program for children of ages from two to six years.

Other features and advantages of the invention will be apparent from the following specifications, taken in conjunction with the following drawings.

The present invention overcomes the limitations of the previous ones by providing an integral floor mat combining different gross motor skills, working as an educational and recreational tool at the same time.

The invention itself, both as to its configuration and its mode of operation will be best understood, and additional objects and advantages thereof will become apparent, by the following detailed description of a preferred embodiment taken in conjunction with the accompanying drawings.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings, which are incorporated herein, constitute part of the specifications and illustrate the preferred embodiment of the invention.

FIG. 1 shows a general view of the preferred embodiment in accordance with principles of the current disclosure.

FIG. 2 shows a first example of an interactive ‘cone topper’ in accordance with the principles of the current disclosure.

FIG. 3 shows a first example of a ‘jump n’ touch′ in accordance with the principles of the current disclosure.

FIG. 4 shows a first example of a ‘rubberized hurdles’ in accordance with the principles of the current disclosure.

FIG. 5 shows a general view of the preferred embodiment interacting with all of the system elements in accordance with the principles of the current disclosure.

### DESCRIPTION OF THE PREFERRED EMBODIMENT

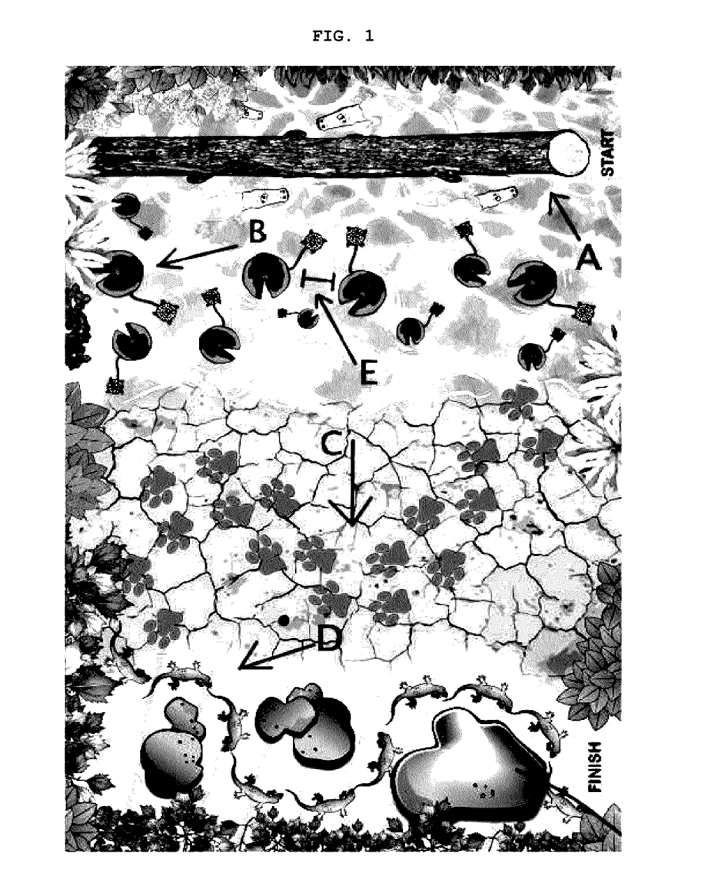

FIG. 1 shows a mat with drawings resembling a jungle forming an obstacle course with the four stages it has to work and develop different motor skills; stage A has a drawing resembling a straight line element, said stage is used to work balance; stage B has a drawing resembling a pattern element, said stage is used to work lower-body strength; stage C has a pattern element with more separation, said stage is used to work upper body strength; stage D has an obstacle trail, where lizards a path and desert rocks represent the obstacles, said stage is used to work coordination; this figure also shows the words “START” at one end of the mat and “FININSH” at the other.

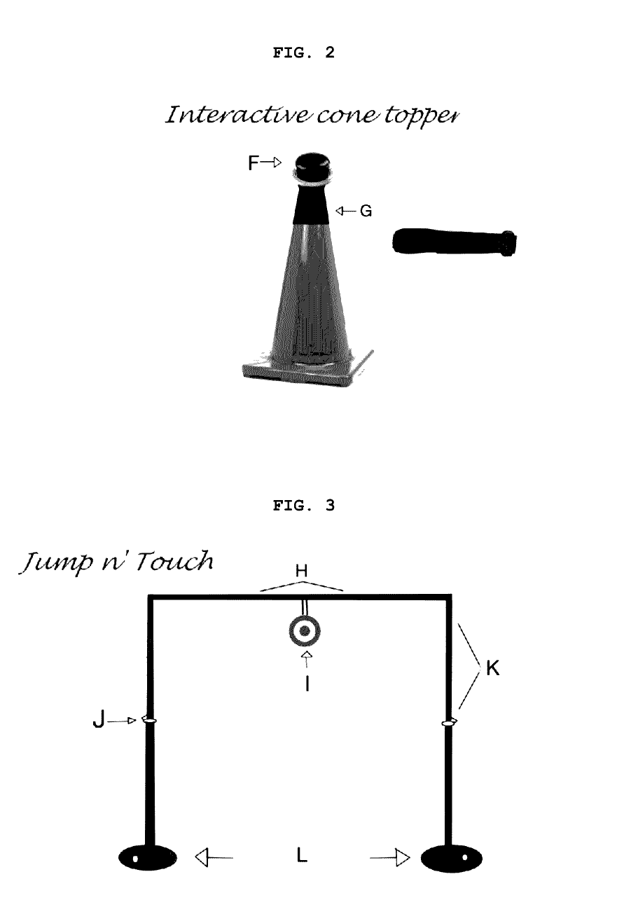

FIG. 2 shows the general structure of a device made to interact with mat from FIG. 1 which includes F, an interactive button which lights and sound once touched, and G, a strap that helps attached it to a cone or an object of similar structure.

FIG. 3 shows the general structure of a device made to interact with mat from FIG. 1 which includes: H, a horizontal pole set at a specific height; K, a pair of vertical poles which can be adjust to a certain height and will the determine the height of H; J, a pair of small hooks used to set the height of K; L, a pair a bases that helps K stay put in the ground; I, a target shaped object placed in the lower side of H.

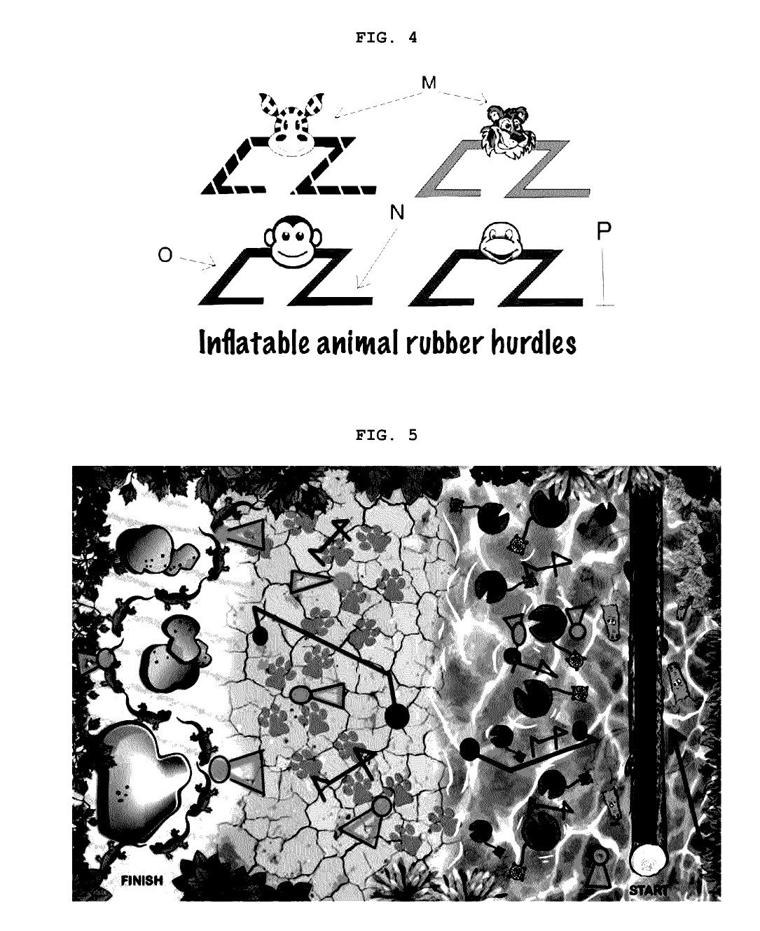

FIG. 4 shows the general structure of a hurdle made to interact with mat from FIG. 1 which includes: M, drawings of different themes of animals, placed on the upper side of the hurdle; O, the rubberized frame of the hurdle; P, the standard height; N, a rubberized inflatable base.

FIG. 5 shows a drawing of the devices shown in FIG. 2, FIG. 3 and FIG. 4 interacting with the platform shown in FIG. 1.

While this invention is susceptible of embodiments in different forms, there are some shown in the drawings and will herein be described in detail the preferred embodiments of the invention with the understanding that the present disclosure is to be considered as an exemplification of the principles of the invention and is not intended to limit the broad aspect of the invention to the embodiments illustrated.

The rubberized surface of said mat, as shown in FIG. 1, will provide stability with the floor and appropriate non-slipping surface for exercises. The mat's upper surface comprises a resemble skill developing playing zone such as a jungle. Each item of design targets a different motor skill. This obstacle course targets: Lower-body strengthening (frog jumps from lily pads to lily pads, as shown in FIG. 1, B), upper body strengthening (crawling following cheetah paws, as shown in FIG. 1, C), balance (cross a log floating on water, as shown in FIG. 1, A), and coordination (run in zigzag through desert rocks, as shown in FIG. 1, D). The words “Start” and “Finish” will be printed to show the sequence that the kids will have to follow.

As shown in FIG. 5, all the additional training equipment will interact with said mat maximizing and increasing difficulty of the targeted skills within said obstacle course. Said additional equipment comprise: (1) a set of interactive ‘Cone toppers’ that emit sound and light and are used to encourage effort in children through measurable tactile goal setting in different activities using said tool, as shown in FIG. 2; (2) a ‘Jump n’ touch′ mechanism used to enforce correct formation in the jumping posture while having to reach an elevated target, as shown in FIG. 3; and (3) a set of ‘Rubberized hurdles’ which are placed between said lily pads to promote a bigger effort through establishing a specific height to jump over, as shown in FIG. 4.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

Having described my invention in detail, what I claim is:

1. A gross motor skills booster program comprising:
a mat with a rubberized upper surface comprising printed material;
wherein said printed material comprises a first indicia wherein said first indicia is a starting point;
wherein said printed material comprises a first stage wherein said first stage comprises an elongated element surrounded by the representation of first animal;
wherein said printed material comprises a second stage wherein said second stage comprises a first indicia path;
wherein said printed material comprises a third stage wherein said third stage comprises a second indicia path;
wherein said printed material comprises a fourth stage wherein said fourth stage comprises a third indicia path surrounded by the representation of second animal;
wherein said printed material comprises a second indicia wherein said second indicia comprises a finish point;
an obstacle item wherein said obstacle item comprises a horizontal element, a pair of vertical elements which supports said horizontal element, and a pair of horizontal bases attached to each said vertical elements, wherein said horizontal and vertical elements, and said horizontal bases, are made of rubberized material and are inflatable;
wherein said obstacle item interacts and increases difficulty of second and third stages;
a device wherein said device comprises an interactive button wherein said interactive button lights and sounds once touched, and a strap wherein said strap helps attach said interactive button to a cone shaped structure;
wherein said device interacts with first, second, third and fourth stages;
a jumping element wherein said jumping element comprises a horizontal pole set at a specific height, a pair of vertical poles which can be adjust to a certain height and will determine the height of said horizontal pole, a pair of small hooks used to set the height of said vertical poles, a pair of bases that helps said vertical poles to stay put on the ground, and a target shaped object placed in the lower side of said horizontal pole;
wherein said jumping element interacts and increases difficulty of second and third stages.

2. The gross motor skills booster program device according to claim 1, wherein said first indicia path comprises lily pads.

3. The gross motor skills booster program device according to claim 1, wherein said second indicia path comprises cheetah paws.

4. The gross motor skills booster program device according to claim 1, wherein said third indicia path comprises desert rocks.

5. The gross motor skills booster program device according to claim 1, wherein each item of the design targets a specific gross motor skill.

6. The gross motor skills booster program device according to claim 1, wherein said first stage targets the balance skill.

7. The gross motor skills booster program device according to claim 1, wherein said second stage targets lower-body strengthening.

8. The gross motor skills booster program device according to claim 1, wherein said third stage targets upper-body strengthening.

9. The gross motor skills booster program device according to claim 1, wherein said fourth stage targets coordination.

10. The gross motor skills booster program according to claim 1, wherein said jumping element comprises a horizontal pole set at a specific height, a pair of vertical poles which can be adjust to a certain height and will determine the height of said horizontal pole, a pair of small hooks used to set the height of said vertical poles, a pair of bases that helps said vertical poles to stay put on the ground, and a target shaped object placed in the lower side of said horizontal pole, interacts and increases difficulty of said second and third stages.

11. The gross motor skills booster program according to claim 1, wherein said obstacle item comprises a horizontal element, a pair of vertical elements which supports said horizontal element, and a pair of horizontal bases attached to each said vertical elements, wherein said horizontal and vertical elements, and said horizontal bases, are made of rubberized material and are inflatable, interacts and increases difficulty of said third stage.

12. The gross motor skills booster program according to claim 1, wherein said device comprises an interactive button wherein said interactive button lights and sounds once touched, and a strap wherein said strap helps attach said interactive button to a cone shaped structure, interacts and increases difficulty of said first, second, third and fourth stages.

13. The gross motor skills booster program device according to claim 1, wherein the program is intended to develop the skills on children from two to six years of age.
